(19) United States
(12) Patent Application Publication
(10) Pub. No.: US 2021/0001510 A1
(43) Pub. Date: Jan. 7, 2021

(54) LOG SPLITTING DEVICE

(71) Applicant: Peter Washington, Salem, OR (US)

(72) Inventor: Peter Washington, Salem, OR (US)

(21) Appl. No.: 16/921,820

(22) Filed: Jul. 6, 2020

Related U.S. Application Data
(60) Provisional application No. 62/870,521, filed on Jul. 3, 2019.

(51) Int. Cl. B27L 7/06; B27L 7/00

(52) U.S. Cl. CPC B27L 7/06; B27L 7/005

(57) ABSTRACT

A tool for log-splitting is provided with a handle structure defining a long axis, and including a first handle and a second handle. The handles extend substantially parallel to the long axis. Coupled to the handles are an axe head including a first wedge and a second wedge with the axe head extending perpendicularly from the long axis of the handle structure to a sharpened edge. The wedges are coupled by a hinged joint providing for the first and second wedges selectively to be aligned together and to be separated. The first wedge includes a notch behind the sharpened edge and the second wedge includes a leading edge that, with the wedges aligned together, is positioned in the notch.

### CROSS-REFERENCE TO RELATED APPLICATION

This application claims priority under 35 U.S.C. § 119 to U.S. Provisional Patent Application No. 62/870,521, filed on Jul. 3, 2019, the contents of which are hereby incorporated by reference in their entirety for all purposes.

### FIELD OF THE DISCLOSURE

The field of the present disclosure includes tools using wedging and leveraging properties. The field of the present disclosure is directed more specifically to a splitting tool that may be used on logs. The tool has a two-piece head that may be coupled in a hinged manner, that allows the user to embed a cutting edge of the head in a log and then pull apart the two pieces of the head to aid in splitting the log.

### BACKGROUND AND SUMMARY OF THE DISCLOSURE

Various apparatuses and methods are known in the prior art for embedding and driving a wedge or blade to split a piece of wood along the grain of the wood. The prior art shows various ways of levering the wedge. For example, U.S. Pat. No. 128,830 discloses a knife-like structure combined with a rack where a tip of the knife can be levered. U.S. Pat. No. 4,244,407 is similar in providing a leveraging rack for an axe-headed device. U.S. Pat. No. 4,354,537 relatedly combines a jack-like structure for driving an axe head to split a piece of wood. U.S. Pat. No. 7,040,362 also uses a ratcheting structure, similar to a jack, in a log-splitter.

The prior art also shows two-piece axe heads that allow relative movement of the pieces. U.S. Pat. No. 4,130,270 shows an axe head with two blades with sharpened edges that are positioned alongside one another. The blades also include notches and a hinged leverage device for ratcheting the blades into the wood. U.S. Pat. No. 4,381,809 also provides an axe head with two wedges and a hinge within the axe head structure. In the '809 patent, a third, internal wedge drives the wedges apart. U.S. Pat. No. 4,440,205 shows a more complicated axe head with a single wedge, where the axe head also includes chocks that are mounted on a hinge inside the wedge.

U.S. Pat. No. 4,789,134 is also a two-piece structure, although it is not explicitly used as an axe. Also two-piece structures are U.S. Pat. No. 5,020,225 and US Pub 2011/0126942. The '942 publication has handles alongside one another but no integral axe head. Instead the '942 publication requires separate use of a wedge.

U.S. Pat. No. 5,454,410 also has a two-piece structure with a hinged connection and one handle on each side of the hinge but is not otherwise like an axe. U.S. Pat. No. 6,533,004 illustrates driving a wedge into the wood with the aid of a weight moveable along the handle.

### BRIEF DESCRIPTION OF THE DRAWINGS

FIG. 1 is an illustration of an embodiment of the present disclosure showing an axe with a head including two portions, each portion attached to a handle and to a rod opposite the handle, the two rods being coupled at a hinge.

FIG. 2 is an illustration of the embodiment of FIG. 1 showing the two portions of the axe head swinging apart as allowed by the hinge, and also showing the hinge as unconnected for illustrative purposes.

FIG. 3 is a pictorial view showing one of the portions of the axe head of FIG. 1 including a brace for attaching to the handle and also this portion's rod and a half of the hinge.

FIG. 4 is a pictorial view showing the other portion of the axe head of FIG. 1 showing a brace for attaching to the handle and also this portion's rod and the other half of the hinge.

FIG. 5 is a pictorial view showing a component for either one of the handles of FIG. 1, in particular a grip for holding the handle.

FIG. 6 is a pictorial view showing a component for either one of the handles of FIG. 1, in particular a coupler for interconnecting extendable parts of the handles.

FIG. 7 is a pictorial view showing a component for either one of the handles of FIG. 1, in particular a fixed part that couples to the brace at the head portion and to an extendable part.

FIG. 8 is a pictorial view showing a component for either one of the handles of FIG. 1, in particular an extendable part that couples to the fixed part of FIG. 7, and showing a brake for limiting the extension.

FIG. 9 is a pictorial view showing the device of FIG. 1 with the axe head embedded in a log and with the handles together.

FIG. 10 is a pictorial view showing the device as in FIG. 9 with the axe head embedded in a log and now with the handles spread apart and the log separated into two pieces.

FIG. 11 is a pictorial view of an axe head, similar to that in FIG. 1, with a more square structure for the two portions of the axe head.

FIG. 12 is a pictorial view of the axe head of FIG. 11, from a reverse angle.

FIGS. 13a-d are photographs of a prototype of an embodiment of the present disclosure showing (a) a user embedding the axe head in a log, (b) the user beginning to spread the axe head apart, (c) the user spreading the axe head further apart to separate the log into two pieces, (d) the user drawing the axe head back together as one piece of the log falls off of the other.

FIGS. 14a-b are photographs of another prototype of another embodiment of the present disclosure showing (a) a user embedding the axe head in a log and (b) the user spreading the axe head apart to separate the log into two pieces.

FIG. 15 is a photograph of the embodiment of FIG. 14a-b showing the axe head, the handles, the hinge, and a slotted guard bolted to one handle and providing a slot to receive the other handle when they are swung together.

FIG. 16 is a photograph of the embodiment of FIGS. 14a-b and 15 showing the axe head and the portions of the axe head, as well as the slotted guard.

FIG. 17 is a photograph of the embodiment of FIGS. 14a-b and 15-16 showing the axe head and the portions of the axe head, as well as the hinge and the slotted guard and with the handles swung apart.

FIG. 18 is a photograph of the embodiment of FIGS. 13a-d showing the axe head and the portions of the axe head, as well as the hinge and the slotted guard.

### DETAILED DESCRIPTION OF THE DISCLOSURE

Embodiments of the present disclosure are directed to a log splitting tool that has a hinged structure and a two-piece head, like that of an axe, which allows the user to embed the cutting edge of the head in a log and then pull apart the two pieces of the axe head to aid in splitting the log.

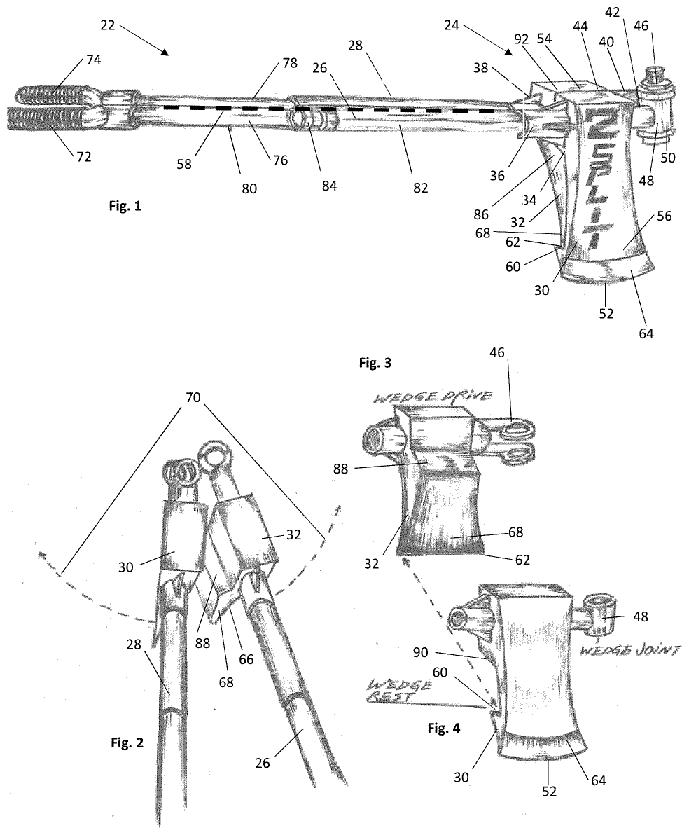

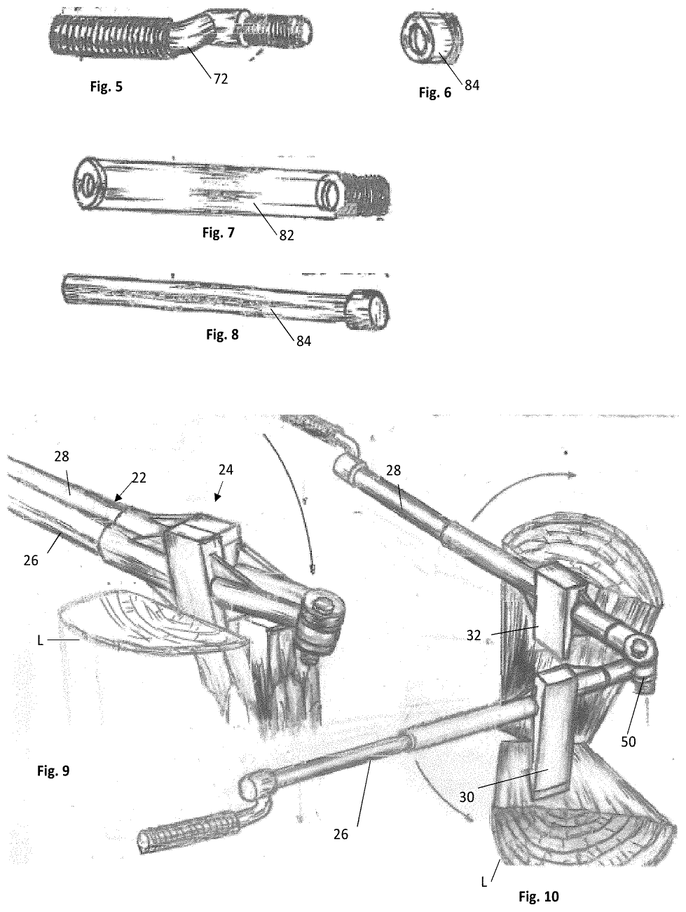

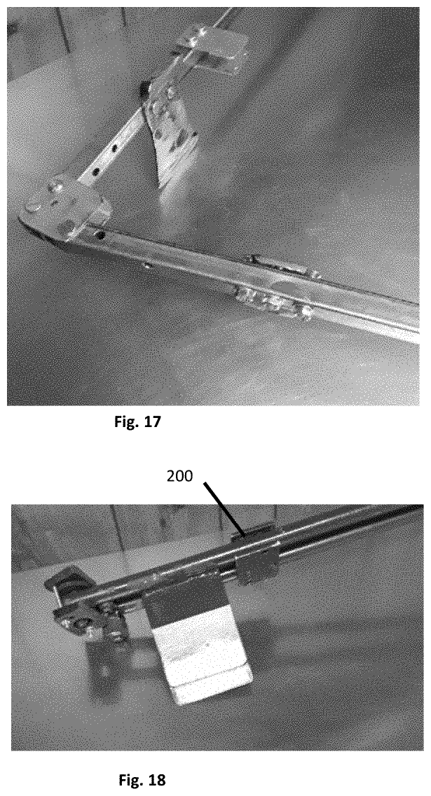

Structures for various embodiments of the present disclosure are depicted in FIGS. 1-18. A tool 20 may have an overall configuration generally like that of an axe useful for splitting wood along the wood's grain. Tool 20 may include a handle structure 22 and an axe head 24 that may be swung and/or hammered into a log or other structure to split or otherwise break apart the structure.

Handle structure 22 typically includes two handles: a right handle 26 and a left handle 28. Handle structure 22 defines a long axis 58 (FIG. 1) and the left and right handles typically extend substantially parallel to the long axis. Handle structure 22 is typically lightweight in comparison to axe head 24 to facilitate development of kinetic force in axe head 24 by a user's swinging tool 20, e.g., in a downward motion, while holding handle structure 22.

Each handle may include a grip portion, such as curved grips 72, 74 suitable to be held by the user and a shaft portion 76, 78 that may extend from the grip to the axe head. Curved grips may facilitate the user's holding handle structure 22 with one grip in each hand while swinging the tool and/or spreading the handles, as will be described below.

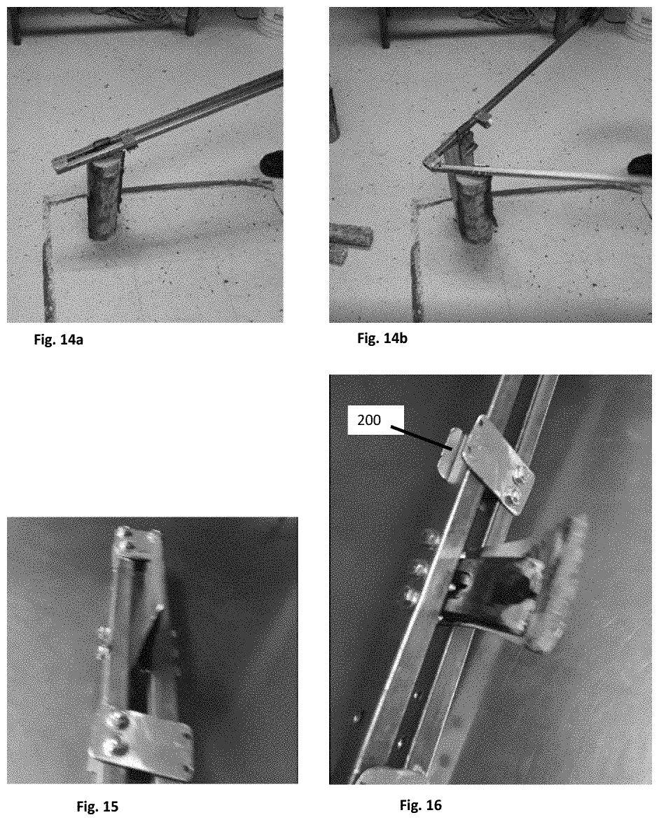

One or both of handles 26, 28 may be adjustable in length, for example as shown in FIG. 1, by having two sections 80, 82, slidable with respect to one another and connected with a coupler 84 for locking the two sections in place at a desired length. Handles 26, 28 may have a circular cross-section as shown in FIGS. 1-2, or a rectangular cross-section as shown in FIGS. 14a-17, or any other cross-section suitable to the specific application of the tool.

Axe head 24 may include two portions: a cutting wedge 30 and a driving or splitting wedge 32. Handles 26, 28 may be coupled to a proximal side 34 of axe head 24. Right handle 26 may attach, e.g. at a brace 36, to driving wedge 32 and left handle 28 may attach, e.g. at a brace 38, to cutting wedge 30, as shown in FIG. 1. Alternatively, right handle 26 may be attached to cutting wedge 30 and left handle 28 may be attached to driving wedge 32, as shown in FIG. 2.

A pair of rods 40, 42 may extend from axe head 24 adjacent a distal side 44 of axe head 24 opposite proximal side 34 where handles 26, 28 are attached. Rods 40, 42 may each be attached at a first end to one of cutting wedge 30 and driving wedge 32. Alternatively, one or both of rods 40, 42 may be formed integrally with the respective wedges.

Rods 40, 42 may each be attached at a second end to one of two rotatable components 46, 48 of a hinge 50. Alternatively, cutting wedge 30 and driving wedge 32 may be coupled together in any manner suitable for selectively aligning the wedges together and separating the wedges. Typically, the wedges are aligned together for an operation of forcing (for example, swinging or hammering) axe head 24 into the object to be split and then separated to split the object apart.

Cutting wedge 30 and driving wedge 32 may fit together to form a combined wedge shape 86 generally like that of a typical axe head. For example, axe head 24 may have a wedge shape with a thick or wide end 54 and a narrow or tapering end 56. Typically, thick end 54 is attached to handle structure 22, and the wedge narrows in a direction extending away from the handle structure. For example, the direction may be perpendicular to a long axis 58 of the handle structure, as shown in FIG. 1. Narrow end 56 culminates in a sharpened edge 52.

Each of cutting wedge 30 and driving wedge 32 typically include a roughly-wedged shape with certain features that allow them to fit together into a combined wedge shape. The features may include a wedge rest, such as a ledge or notch 60 behind sharpened edge 52 of cutting wedge 30. That is to say, notch 60 is typically located closer to handle structure 22 than sharpened edge 52 is to handle structure 22.

Notch 60 may allow a leading edge 62 of driving wedge 32 to be positioned out of the way when sharpened edge 52 is swung or driven into log L. Cutting edge 30 and driving wedge 32 may each have an angled face 64, 66, respectively, that each contribute to the roughly-wedged shape of axe head 24. The structure for positioning driving wedge 32 out of the way may facilitate the forcing of the axe head, for example, sharpened edge 52 and angled faces 64, 66 into log L. That is, leading edge 62 does not strike log L when axe head 24 is swung onto the log, nor does leading edge 62 contact log L as axe head 24 is driven into the log, for example, by hammering.

Driving wedge 32 and cutting wedge 30 may be formed with complementary shapes for fitting the wedges together into combined wedge shape 86. For example, driving wedge 32 may be shaped to include an angled surface 88 that corresponds to an angled surface 90 on cutting wedge 30, which shape/surfaces may cooperate to provide a fitted coupling between cutting wedge 30 and driving wedge 32. The coupling of the wedges may aid in transferring the swung or hammered force of axe head 24 to sharpened edge 52.

Sharpened edge 52 of cutting wedge 30 may be embedded in a log L, as seen for example in FIGS. 9 and 10, by the user's swinging the axe and/or by the user's hammering on wide end 54 of axe head 24 at surface 92. The roughly-wedged shape, provided in part by faces 64, 66, facilitates the advancing of sharpened edge 52 through the surface of log L into the body of the log.

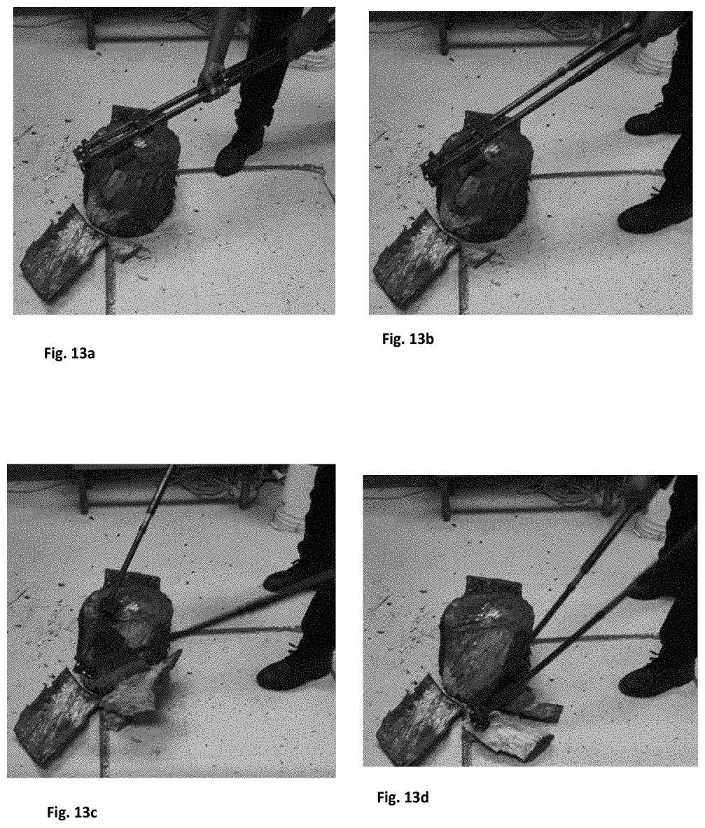

Splitting the log may be facilitated by spreading handles 26, 28 when axe head 24 is embedded in log L at least deep enough that leading edge 62 and at least some of a lower portion 68 of driving wedge 32 is below an upper surface of log L (FIGS. 9, 13a, 14a). In this condition, the user's pulling the handles 26, 28 apart, using hinge 50, pulls apart the wedges 30, 32 that are the two pieces of axe head 24, and pulls apart the two sides of log L, as shown in FIGS. 10, 13b-d, and 14b.

One example of use of the adjustable length would be to use a shorter length for swinging the axe with greater control to align it with a desired strike location on log L, and then, with the axe head embedded in the log, to extend the handles to a longer length for greater leverage in splitting the log. FIG. 2 also illustrates with arrows 70 the motion of handles 26, 28 moving apart to spread driving wedge 32 away from cutting wedge 30.

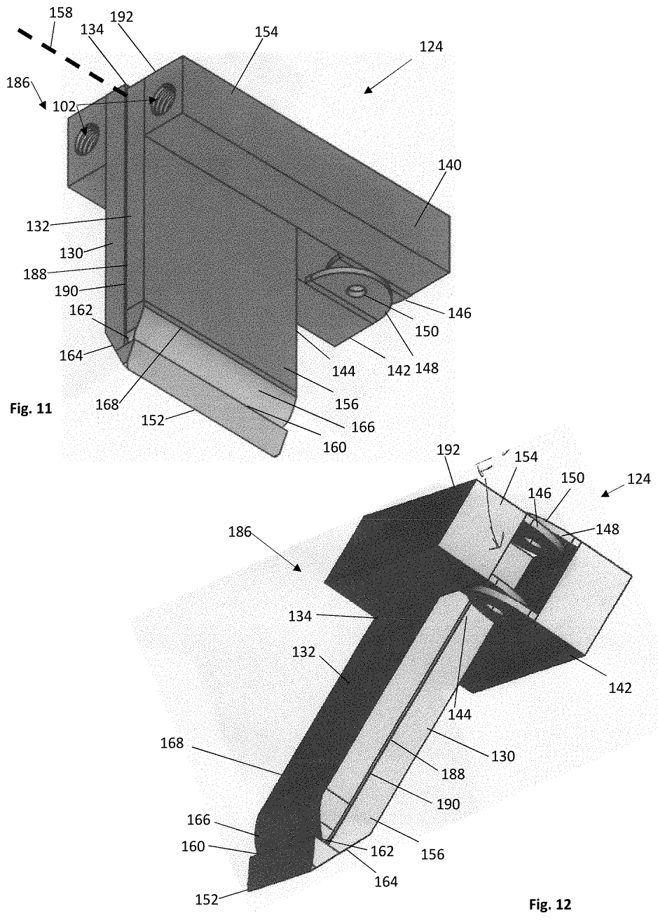

Another embodiment of the axe head is illustrated in FIGS. 11 and 12, and described using reference numerals to which 100 has been added as compared to the corresponding description for FIGS. 1-10. As shown in FIGS. 11-12, an axe head 124 of a tool 120 may include structure, e.g., threaded holes 102, for connecting axe head 124 to a handle structure that includes a left and right handle similar in structure to that described for FIGS. 1-10. Such handle structure would define a long axis 158.

Axe head 124 may include two portions: a cutting wedge 130 and a driving or splitting wedge 132. Threaded holes 102 may be provided at a proximal side 134 of axe head 124. A pair of rods 140, 142 may extend from axe head 124 adjacent a distal side 144 of axe head 124 opposite proximal side 134. As shown in FIGS. 11 and 12, rods 140, 142 may each be attached (for example, by welding or integral forming by casting, along the top of the wedges and extend beyond distal side 144.

Rods 140, 142 may each be attached at a second end to one of two rotatable components 146, 148 of a hinge 150. Alternatively, cutting wedge 130 and driving wedge 132 may be coupled together in any manner suitable for selectively aligning the wedges together and separating the wedges. As with the embodiment of FIGS. 1-10, the wedges may be aligned together for an operation of forcing (for example, swinging or hammering) axe head 124 into the object to be split and then separated to split the object apart.

Cutting wedge 130 and driving wedge 132 may fit together to form a combined wedge shape 186 generally like that of a typical axe head. For example, axe head 124 may have a wedge shape with a thick or wide end 154 and a narrow or tapering end 156. Typically, thick end 154 is attached to the handle structure, and the wedge narrows in a direction extending away from where the handle structure attaches. For example, the direction may be perpendicular to long axis 158 of the handle structure, as shown in FIGS. 11 and 12. Narrow end 156 culminates in a sharpened edge 152.

Each of cutting wedge 130 and driving wedge 132 typically include a roughly-wedged shape with certain features that allow them to fit together into a combined wedge shape. The features may include a wedge rest, such as a ledge or notch 160 behind sharpened edge 152 of cutting wedge 130. That is to say, notch 160 is typically located closer to where the handle structure attaches than sharpened edge 52 is to where the handle structure attaches.

Notch 160 may allow a leading edge 162 of driving wedge 132 to be positioned out of the way when sharpened edge 152 is swung or driven into log L. Cutting edge 130 and driving wedge 132 may each have an angled face 164, 166, respectively, that each contribute to the roughly-wedged shape of axe head 124. The structure for positioning driving wedge 132 out of the way may facilitate the forcing of sharpened edge 152 and angled faces 164, 166 of the axe head into log L. That is, leading edge 162 does not strike log L when axe head 124 is swung onto the log, nor does leading edge 162 contact log L as axe head 124 is driven into the log, for example, by hammering.

Driving wedge 132 and cutting wedge 130 may be formed with complementary shapes for fitting the wedges together into combined wedge shape 186. For example, driving wedge 132 may be shaped with a flat inner side surface 188 that corresponds to a flat inner side surface 190 on cutting wedge 130, which surfaces may cooperate to provide a fitted coupling between cutting wedge 130 and driving wedge 132. The coupling of the wedges may aid in transferring the swung or hammered force of axe head 124 to sharpened edge 152.

Sharpened edge 152 of cutting wedge 30 may be embedded in a log L, as described above for the embodiment of FIGS. 1-10, by the user's swinging the axe and/or by the user's hammering on wide end 154 of axe head 124 at surface 192. The roughly-wedged shape, provided in part by faces 164, 166, facilitates the advancing of sharpened edge 152 through the surface of log L into the body of the log.

Splitting the log may be facilitated by spreading the handles attached to axe head 124 when it is embedded in log L at least deep enough that leading edge 162 and at least some of a lower portion 168 of driving wedge 132 is below an upper surface of log L similar to the manner described for the embodiment of FIGS. 1-10. In this condition, the user's pulling the handles apart, using hinge 150, pulls apart the wedges 130, 132 that are the two pieces of axe head 124, and pulls apart the two sides of log L, similar to the manner described for FIGS. 1-10.

Alternative embodiments are depicted in FIGS. 13a-18. These embodiments are generally similar to that described above for FIGS. 1-12. Additionally, these embodiments include a slotted guard 200 that may aid in aligning the handles with one another with the wedges together, and holding the relative position of the handles and wedges while the tool is swung and/or hammered. The various embodiments illustrate that the position of the hinge relative to the wedges, the length of the handles, and the relative sizes of the structures of the wedges may be varied as best suited to a particular application of the tool.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

The invention claimed is:

1. A tool for splitting a log, the tool comprising:
a. a handle structure defining a long axis, and including a first handle and a second handle, the handles extending substantially parallel to the long axis;
b. an axe head defining a proximal side and a distal side opposite the proximal side, and including a first wedge and a second wedge, wherein the first wedge is coupled to the first handle adjacent the proximal side of the axe head, and wherein the second wedge is coupled to the second handle adjacent the proximal side of the axe head, and wherein the axe head extends substantially perpendicularly from the long axis of the handle structure to a sharpened edge; and
c. a hinged joint coupling the first and second wedges adjacent the distal sides of the wedges, the hinged joint providing for the first and second wedges selectively to be aligned together and to be separated,
and further wherein the first wedge includes a notch behind the sharpened edge and the second wedge includes a leading edge that, with the wedges aligned together, is positioned in the notch.

2. The tool of claim 1 wherein the first wedge includes an angular face adjacent the sharpened edge, and the second wedge includes an angular face adjacent the leading edge.

3. The tool of claim 1 wherein the wedges are configured for the leading edge of the second wedge not contacting the log when the sharpened edge of the first wedge is embedded into the log.

4. The tool of claim 1 wherein at least one of the handles is adjustable in length.

5. The tool of claim 1 wherein the handles include curved grips providing a space for a user's fingers in between the grips.
